(19) United States
(12) Patent Application Publication
(10) Pub. No.: US 2015/0346814 A1
(43) Pub. Date: Dec. 3, 2015

(54) GAZE TRACKING FOR ONE OR MORE USERS

(71) Applicants: Vaibhav Thukral, Kirkland, WA (US); Ibrahim Eden, Redmond, WA (US); Shivkumar Swaminathan, Woodinville, WA (US); David Nister, Bellevue, WA (US); Morgan Venable, San Francisco, CA (US)

(72) Inventors: Vaibhav Thukral, Kirkland, WA (US); Ibrahim Eden, Redmond, WA (US); Shivkumar Swaminathan, Woodinville, WA (US); David Nister, Bellevue, WA (US); Morgan Venable, San Francisco, CA (US)

(21) Appl. No.: 14/291,254

(22) Filed: May 30, 2014

(51) Int. Cl. G06F 3/01; H04N 7/18; G06K 9/00

(52) U.S. Cl. CPC G06F 3/013; G06K 9/0061; H04N 7/18

(57) ABSTRACT

One or more techniques and/or systems are provided for gaze tracking of one or more users. A user tracking component (e.g., a depth camera or a relatively lower resolution camera) may be utilized to obtain user tracking data for a user. The user tracking data is evaluated to identify a spatial location of the user. An eye capture camera (e.g., a relatively higher resolution camera) may be selected from an eye capture camera configuration based upon the eye capture camera having a view frustum corresponding to the spatial location of the user. The eye capture camera may be invoked to obtain eye region imagery of the user. Other eye capture cameras within the eye capture camera configuration are maintained in a powered down state to reduce power and/or bandwidth consumption. Gaze tracking information may be generated based upon the eye region imagery, and may be used to perform a task.

### BACKGROUND

Many users perform tasks using computing devices. In an example, a user may map directions from a current location to an amusement park using a mobile device. In another example, a user may read a book using a tablet device. Various types of input may be used to perform tasks, such as touch gestures, mouse input, keyboard input, voice commands, motion control, etc. An object detection component may, for example, be configured to visually detect body movement of a user as input for performing tasks and/or commands.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for gaze tracking are provided herein. A gaze tracking component may be associated with a user tracking component and an eye capture camera configuration. A user may take affirmative action to provide opt-in consent to allow the gaze tracking component to perform gaze tracking of the user and/or other users. The user tracking component may comprise a depth camera, a passive sensor, an active sensor, an infrared device, a time of flight device, a camera, or any other type of tracking device. The eye capture camera configuration may comprise a plurality of eye capture cameras (e.g., relatively high resolution cameras comprising narrow field of view lenses). In an example, the eye capture cameras are configured according to a fixed view frustum configuration, as opposed to a pan/tilt or other movement configuration that may otherwise reduce durability and/or increase cost of the eye capture camera configuration due to, among other things, moving parts and/or associated controls. In an example, the gaze tracking component maintains the eye capture cameras in a powered down state (e.g., a low power state or an off state) when not in active use for gaze tracking (e.g., an eye capture camera may be powered on while a user is detectable by the eye capture camera, and may be turned off when the user is not detectable by the eye capture camera such as due to the user moving away from the eye capture camera), which may reduce power consumption and/or bandwidth consumption.

In an example of gaze tracking, the gaze tracking component may utilize the user tracking component to obtain user tracking data for a user. The gaze tracking component may evaluate the user tracking data to identify a spatial location of the user. An eye capture camera may be selected from the eye capture camera configuration based upon the eye capture camera having a view frustum corresponding to the spatial location. The eye capture camera may be invoked to obtain eye region imagery of the user. In an example, eye capture cameras having view frustums that do not correspond to the spatial location may be powered down or maintained in the powered down state. The gaze tracking component may generate gaze tracking information for the user based upon the eye region imagery. Various tasks may be performed based upon the gaze tracking information (e.g., a videogame command may be performed, interaction with a user interface may be facilitated, a file may be opened, an application may be executed, a song may be played, a movie may be played, and/or a wide variety of other computing commands may be performed). In an example, the gaze tracking component may be configured to concurrently track gaze tracking information for multiple users that are detected by the user tracking component.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of gaze tracking.

FIG. 2A is a component block diagram illustrating an exemplary system for gaze tracking.

FIG. 2B is a component block diagram illustrating an exemplary system for gaze tracking where a gaze tracking component utilizes a user tracking component to obtain first user tracking data for a first user.

FIG. 2C is a component block diagram illustrating an exemplary system for gazing tracking where a gaze tracking component utilizes one or more eye capture cameras for gaze tracking.

FIG. 2D is a component block diagram illustrating an exemplary system for gazing tracking where a gaze tracking component utilizes one or more eye capture cameras for gaze tracking.

FIG. 2E is a component block diagram illustrating an exemplary system for gaze tracking where a gaze tracking component selectively utilizes one or more eye capture cameras for gaze tracking of multiple users.

FIG. 2F is a component block diagram illustrating an exemplary system for gaze tracking where a gaze tracking component selectively utilizes one or more eye capture cameras for gaze tracking of multiple users.

FIG. 3A is an illustration of an example of performing a first task based upon gaze tracking information for a first user.

FIG. 3B is an illustration of an example of performing a second task based upon gaze tracking information for a first user.

FIG. 4 is an illustration of an exemplary computer readable medium wherein processor-executable instructions configured to embody one or more of the provisions set forth herein may be comprised.

FIG. 5 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more techniques and/or systems for gaze tracking are provided herein. A user tracking component may be utilized to obtain user tracking data for one or more users (e.g., users providing opt-in consent for gaze tracking). When a user is identified as being in a spatial location corresponding to a view frustum of an eye capture camera, then the eye capture camera may be invoked to obtain eye region imagery of the user. The eye region imagery may be used to generate gaze tracking information, which may be used to perform various tasks such as opening files, executing applications, controlling videogames, and/or interacting with user interfaces. Eye capture cameras may be maintained in a powered down state (e.g., turned off) when not actively tracking a user, which may reduce power and/or bandwidth consumption. In an example, gaze tracking information may be concurrently generated and/or tracked for multiple users (e.g., a first user may control a first avatar of a videogame using eye commands, and a second user may concurrently control a second avatar of the videogame using eye commands).

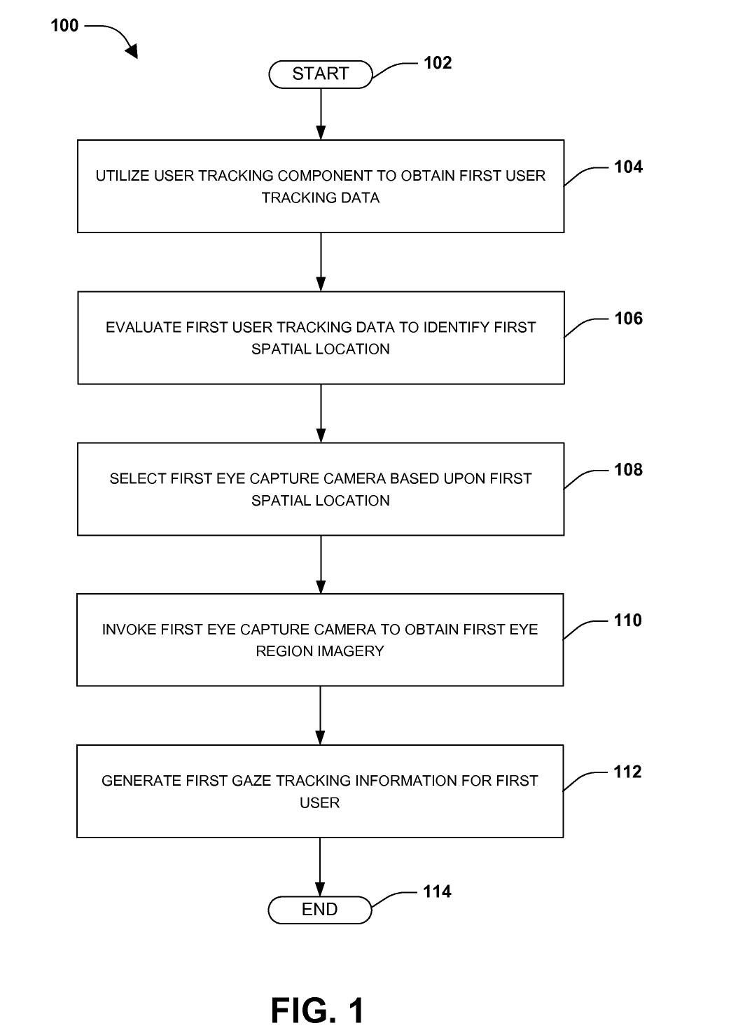

An embodiment of gaze tracking is illustrated by an exemplary method 100 of FIG. 1. At 102, the method starts. A user tracking component may be configured to track spatial locations of one or more users. In an example the user tracking component may comprise a depth camera, a passive sensor, an active sensor, an infrared device, a time of flight device, a camera, and/or any other tracking device. An eye capture camera configuration may comprise a plurality of eye capture cameras configured to obtain gaze tracking information by capturing imagery depicting eyes of users. In an example, an eye capture camera may have a pixel resolution that is greater than the pixel resolution of the user tracking component (e.g., a relatively lower resolution camera may be used to track spatial locations of users, while a relatively higher resolution camera may be used to track user eyes such as a resolution capable of capturing about 150 pixels or more across an eye of a user (e.g., 160 pixels across an eye in an x or horizontal direction)). In an example, the eye capture cameras of the eye capture camera configuration may be configured according to a fixed view frustum configuration (e.g., an eye capture camera may have a fixed field of view and/or may have a stationary non-pan non-tilt configuration that lacks moving parts otherwise used to pan/tilt the camera), which may mitigate cost and/or reliability issues otherwise resulting from a pan/tile or other moveable configuration. In an example of an eye capture camera, the eye capture camera comprises a pupil illumination structure (e.g., a bright pupil ring around the eye capture camera) configured to invoke a pupil response in an eye, which may be detected by the eye capture camera using gaze tracking. In another example of an eye capture camera, an LED dark pupil structure may be turned on to create glint corneal reflections, which may be detected by the eye capture camera using gaze tracking. In an example, two or more eye capture cameras may be configured to capture imagery within overlapping view frustums, which may mitigate distortion of or within the imagery (e.g., which may be more pronounced at edges of the imagery). In an example where at least two eye capture cameras are configured to capture imagery at different depths, a first eye capture camera may be configured to capture imagery within a first view frustum having a first depth, and a second eye capture camera may be configured to capture imagery within a second view frustum having a second depth different than the first depth.

Eye capture cameras may be selectively utilized to concurrently track gaze tracking information of one or more users. In an example, eye capture cameras may be maintained in a powered down state when not being utilized for gaze tracking (e.g., an eye capture camera may be powered on for gaze tracking when a user is within a view frustum of the eye capture camera, and the eye capture camera may be powered down when the user leaves the view frustum), which may mitigate power and/or bandwidth consumption.

At 104, the user tracking component may be utilized to obtain first user tracking data for a first user at a first time T1 (e.g., the user may sit on a couch in a living room within which the user tracking component is located). At 106, the first user tracking data may be evaluated to identify a first spatial location of the first user at the first time T1 (e.g., a spatial location of the couch within the living room). At 108, a first eye capture camera within the eye capture camera configuration may be selected based upon the first eye capture camera having a first view frustum corresponding to the first spatial location (e.g., the first eye capture camera may be positioned towards the couch where the user is sitting, and thus may be capable of capturing imagery of the first user's eyes). At 110, the first eye capture camera may be invoked to obtain first eye region imagery of the first user at or around the first time T1 (e.g., about 150 pixels or more across at least one eye of the first user). In an example, if the first eye capture camera was in a powered down state, then the first eye capture camera may be powered on and instructed to capture imagery that may depict the first user's eyes.

At 112, first gaze tracking information for the first user (e.g., corresponding to the first time T1) may be generated based upon the first eye region imagery (e.g., the first eye region imagery may comprise a plurality of images indicating pupil/eye movement by the first user). A task may be performed based upon the first gaze tracking information. For example, the first gaze tracking information may indicate that the user looked left, which may be mapped to a command that may be executed to perform a task (e.g., a look left gaze input may be mapped to a steer car left input for a driving videogame; the look left gaze input may be mapped to a play previous song input for a music player app; the look left gaze input may be mapped to a backspace input for a typing interface; etc.). It may be appreciated that a wide variety of tasks may be performed (e.g., controlling a videogame based upon analog and/or digital commands derived from gaze tracking information), and that merely a few examples are provided.

In an example of gaze tracking where the user is located within overlapping view frustums, a second eye capture camera may be selected from the eye capture camera configuration based upon the second eye capture camera having a second view frustum corresponding to the first spatial location (e.g., the user may be sitting on a portion of the couch that corresponds to an overlap between the first view frustum of the first eye capture camera and the second view frustum of the second eye capture camera). The second eye capture camera may be invoked to obtain second eye region imagery of the first user at or around the first time T1. The first eye region imagery and the second eye region imagery may be combined (e.g., using image stitching functionality; measurement combination functionality, and/or any other technique(s)) to generate the first gaze tracking information.

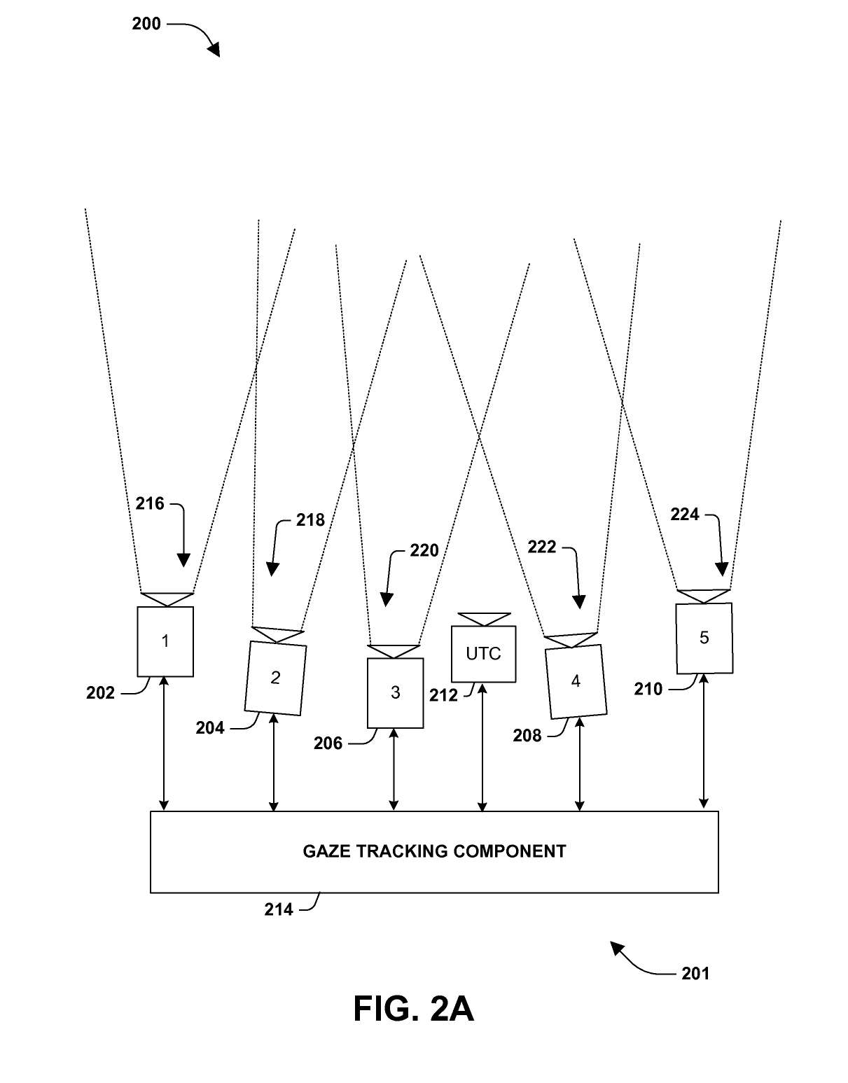

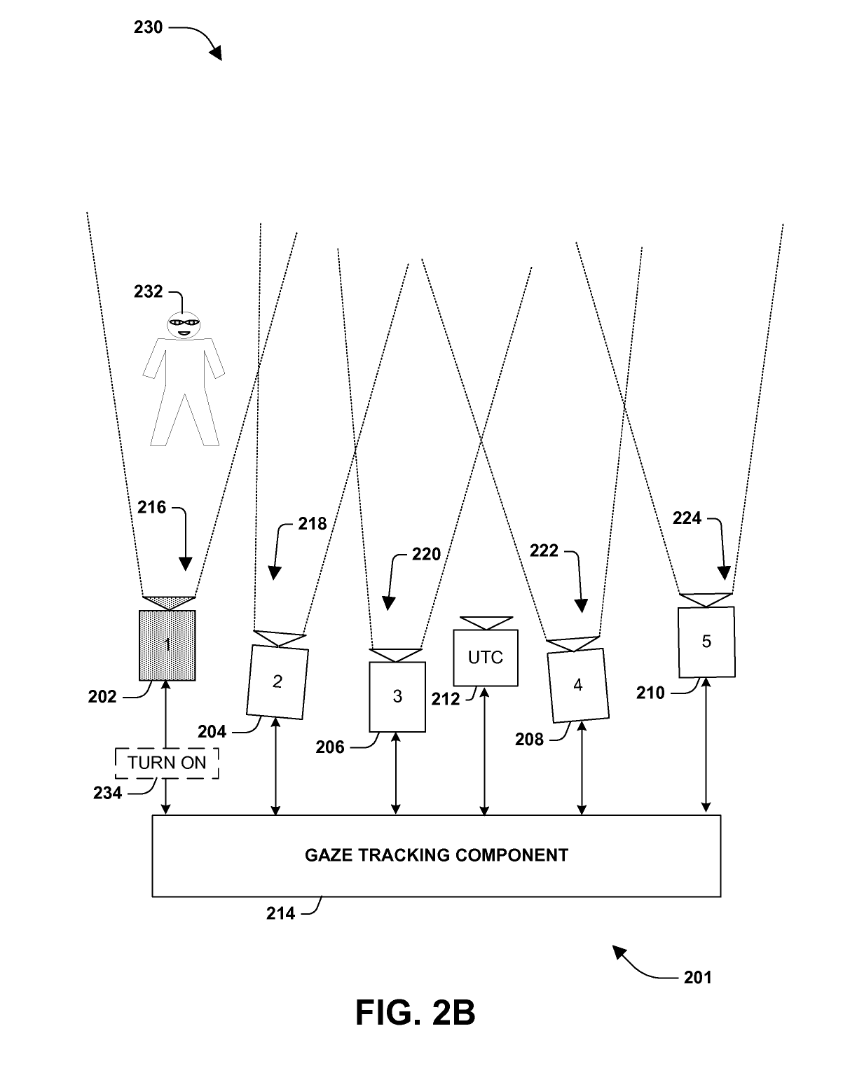

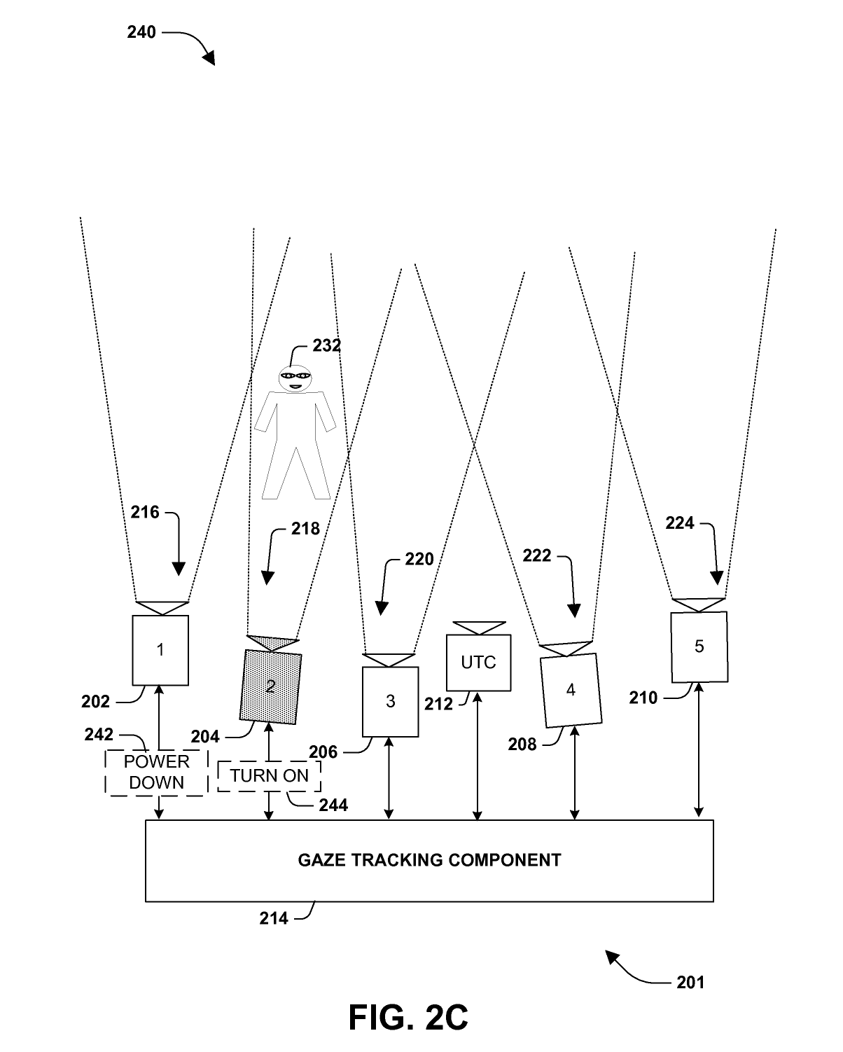

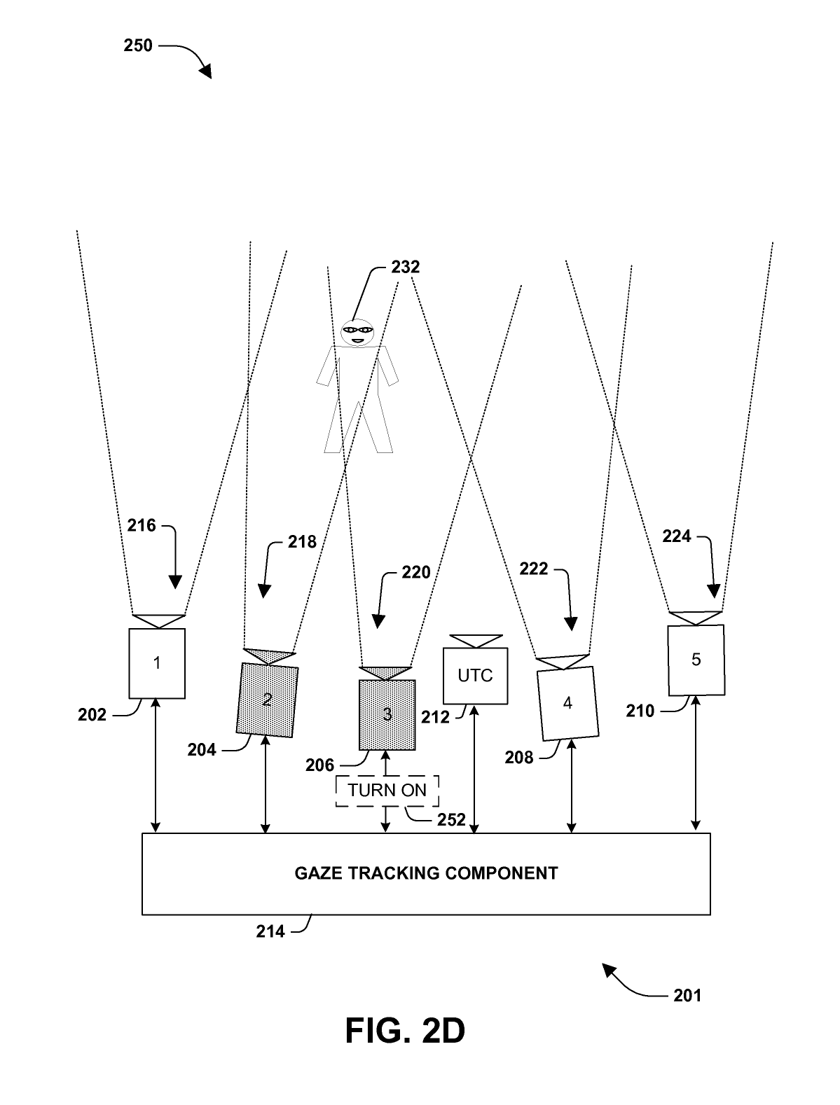

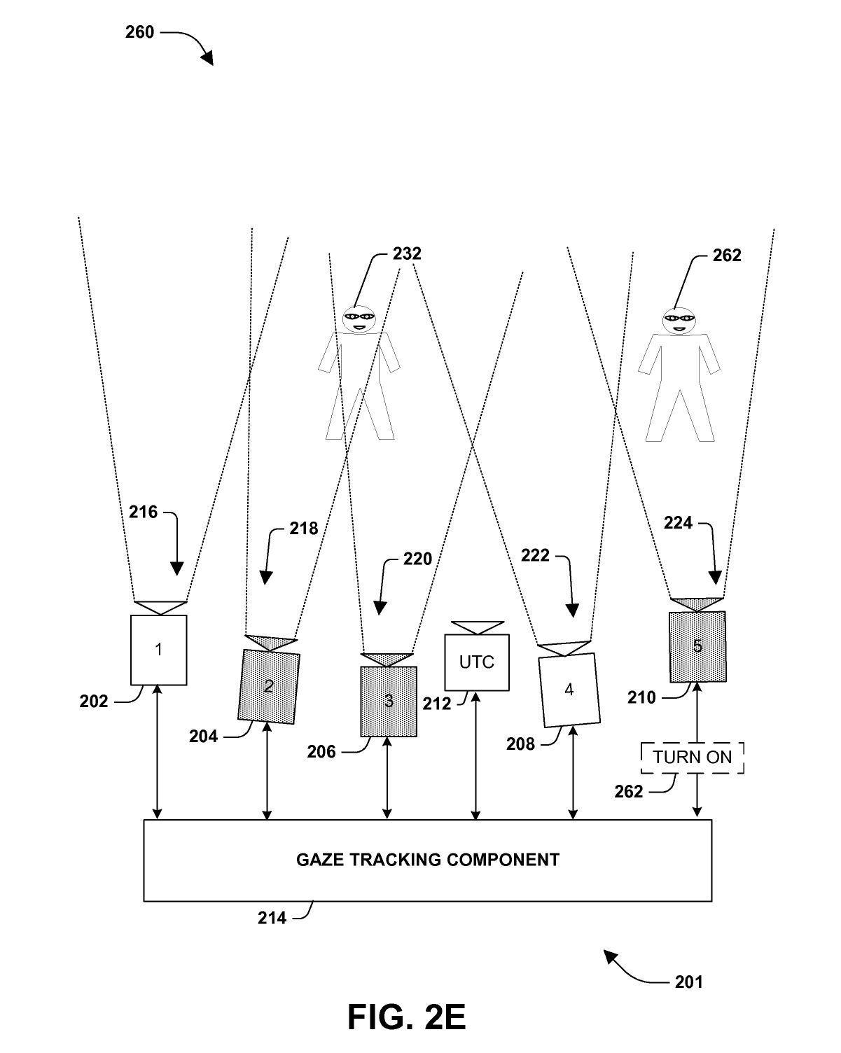

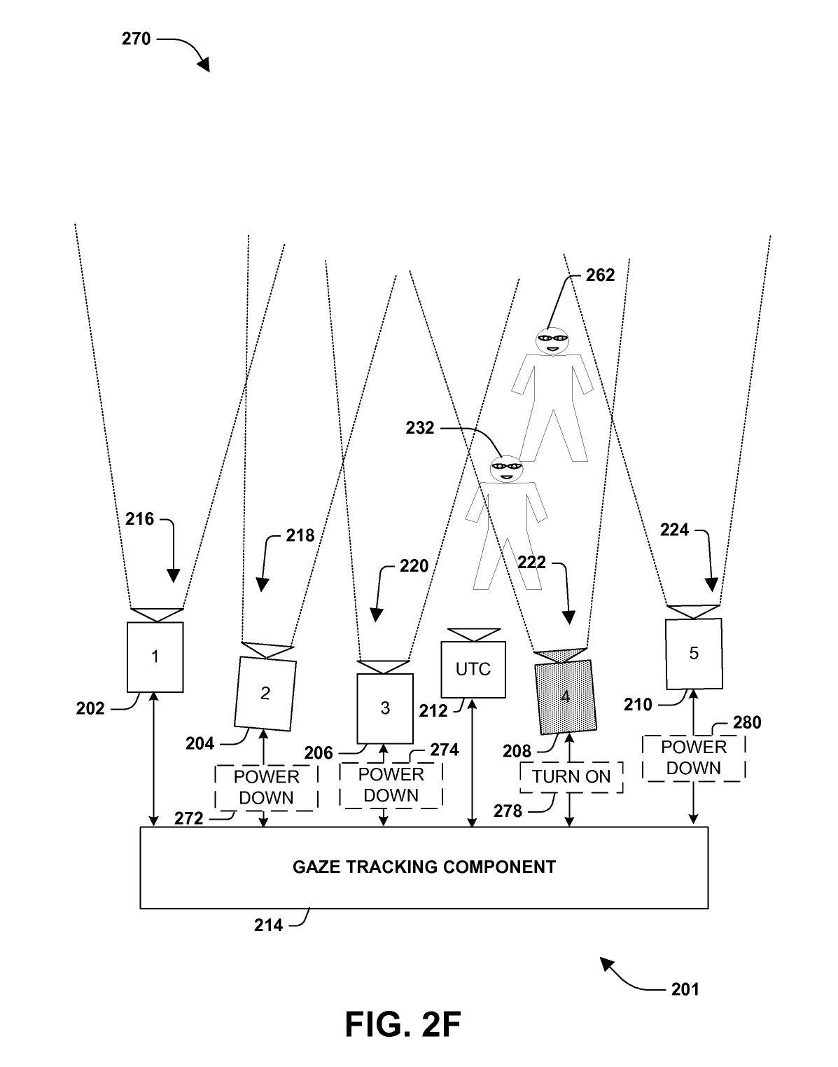

Gaze tracking may be performed for the first user as the first user moves around the living room, such as within detectable range of the user tracking component. In an example, the user tracking component may obtain first user tracking data indicating that the first user is at second spatial location at a second time T2 (e.g., the first user may have walked from the couch to a table in the living room). A third eye capture camera may be selected from the eye capture camera configuration based upon the third eye capture camera having a third view frustum corresponding to the second spatial location (e.g., the user may walk into a third view frustum 220 associated a third camera 206 illustrated in FIG. 2A). If the first view frustum of the first eye capture camera does not correspond to the second spatial location, then the first eye capture camera is transitioned into a powered down state at or around the second time T2. The third eye capture camera may be invoked to obtain third eye region imagery of the first user at or around the second time T2. Third gaze tracking information may be generated for the first user at or around the second time T2 based upon the third eye region imagery. In this way, eye capture cameras may be selectively powered on for obtaining eye region imagery of the first user, and may be selectively powered down when not in use (e.g., an eye capture camera may be powered down when the first user is not within a view frustum of the eye capture camera).

In an example, spatial location data of the first user may be evaluated to predict a potential new spatial location for the first user. For example, previous spatial location data may indicate that the first user is within the first view frustum but is walking towards the second view frustum (e.g., and thus will presumably enter the second view frustum within a particular time/duration). Accordingly, the second eye capture camera may be awakened into a capture ready state for obtaining eye region imagery (e.g., slightly) prior to when the first user is expected/predicted to enter the second view frustum, based upon the spatial location data. In this way, lag associated with obtaining gaze tracking information between multiple eye capture cameras may be mitigated.

Gaze tracking information may be concurrently tracked for multiple users. In an example, the user tracking component may be utilized to obtain second user tracking data for a second user at the first time T1. The second user tracking data may be evaluated to identify a spatial location of the second user at the first time T1. An eye capture camera may be selected from the eye capture camera configuration based upon the eye capture camera having a view frustum corresponding to the spatial location of the second user at the first time T1. The eye capture camera may be invoked to obtain eye region imagery of the second user at or around the first time T1. Gaze tracking information may be generated for the second user based upon the eye region imagery of the second user at the first time T1. In this way, gaze tracking may be concurrently performed for multiple users, which may allow multiple users to perform tasks (e.g., the first user may control a first avatar of a videogame, and the second user may control a second avatar of the videogame). At 114, the method ends.

FIGS. 2A-2F illustrate examples of a system 201 for gaze tracking. FIG. 2A illustrates an example 200 of a gaze tracking component 214. The gaze tracking component 214 may be configured to utilize a user tracking component 212 to track spatial locations of one or more users. The gaze tracking component 214 may selectively invoke eye capture cameras of an eye capture camera configuration to obtain eye region imagery of users at various times for gaze tracking purposes. In an example, the eye capture camera configuration comprises one or more eye capture cameras, such as a first eye capture camera 202 configured to obtain imagery from a first view frustum 216, a second eye capture camera 204 configured to obtain imagery from a second view frustum 218, a third eye capture camera 206 configured to obtain imagery from a third view frustum 220, a fourth eye capture camera 208 configured to obtain imagery from a fourth view frustum 222, a fifth eye capture camera 210 configured to obtain imagery from a fifth view frustum 224, and/or other eye capture cameras (e.g., a relatively high resolution camera, such as about 40MP or greater camera comprising a narrow field of view lens having a horizontal view of about 20 degrees to about 40 degrees (e.g., about a 22 degree horizontal view) and a vertical view of about 10 degrees to about 30 degrees (e.g., about a 17 degree vertical view). In an example, one or more view frustums may overlap, which may mitigate lens distortion around edges of imagery obtained by eye capture cameras. When not in use (e.g., when user tracking data, obtained from the user tracking component 212, indicates a user is not within a view frustum of an eye capture camera), an eye capture camera may be transitioned into a powered down state, which may reduce power and/or bandwidth consumption.

FIG. 2B illustrates an example 230 of the gaze tracking component 214 utilizing the user tracking component 212 to obtain first user tracking data for a first user 232 at a first time T1. The gaze tracking component 214 may evaluate the first user tracking data to identify a first spatial location of the first user 232 at the first time T1. Because the first spatial location corresponds to the first view frustum 216 of the first eye capture camera 202, the gaze tracking component 214 may turn on 234 the first eye capture camera 202 and may invoke the first eye capture camera 202 to obtain first eye region imagery of the first user 232 at or around the first time T1 (e.g., the first eye capture camera 202 may capture imagery comprising about 150 pixels or more across at least one eye of the first user 232). First gaze tracking information may be generated for the first user 232 at the first time T1 based upon the first eye region imagery. One or more tasks may be performed based upon the first gaze tracking information (e.g., the first user 232 may blink a left eye in order to play a song).

FIG. 2C illustrates an example 240 of the gaze tracking component 214 selectively utilizing one or more eye capture cameras for gaze tracking. The gaze tracking component 214 may determine that the user tracking component 212 obtained first user tracking data indicating that the first user 232 is located at a second spatial location at a second time T2. Because the second spatial location corresponds to the second view frustum 218 of the second eye capture camera 204, the gaze tracking component 214 may turn on 244 the second eye capture camera 204 and may invoke the second eye capture camera 204 to obtain second eye region imagery of the first user 232 at or around the second time T2. First gaze tracking information for the first user 232 may be generated for the first user 232 at the second time T2 based upon the second eye region imagery. One or more tasks may be performed based upon the first gaze tracking information (e.g., the first user 232 may blink a right eye in order to stop playing a song). The gaze tracking component 214 may power down 242 the first eye capture camera 202 into a powered down state because the second spatial location of the first user 232 at the second time T2 does not correspond to the first view frustum 216 of the first eye capture camera 202.

FIG. 2D illustrates an example 250 of the gaze tracking component 214 selectively utilizing one or more eye capture cameras for gaze tracking. The gaze tracking component 214 may determine that the user tracking component 212 obtained first user tracking data indicating that the first user 232 is located at a third spatial location at a third time T3. Because the third spatial location corresponds to the second view frustum 218 of the second eye capture camera 204 and the third view frustum 220 of the third eye capture camera 206 (e.g., the third spatial location of the first user 232 at the third time T3 may correspond to an overlap between the second view frustum 218 and the third view frustum 220), the gaze tracking component 214 may turn on 252 the third eye capture camera 206 and may invoke the third eye capture camera 206 to obtain third eye region imagery of the first user 232 at or around the third time T3. In an example, the gaze tracking component 214 may combine (e.g., stitch together) the second eye region imagery obtained by the second eye capture camera 204 and the third eye region imagery obtained by the third eye capture camera 206 to generate gaze tracking information for the user at the third time T3. One or more tasks may be performed based upon the gaze tracking information (e.g., the first user 232 may look right in order to skip to a next song to play).

FIG. 2E illustrates an example 260 of the gaze tracking component 214 selectively utilizing one or more eye capture cameras for gaze tracking of multiple users. In an example, the second eye capture camera 204 and the third eye capture camera 206 may be invoked to capture gaze tracking information for the first user 232 at a fourth time T4 based upon the first user 232 being spatially located in an overlap region between the second view frustum 218 and the third view frustum 220. The gaze tracking component 214 may utilize the user tracking component 212 to obtain second user tracking data for a second user 262 at the fourth time T4. The gaze tracking component 214 may evaluate the second user tracking data to identify a spatial location of the second user 262 at the fourth time T4. Because the spatial location corresponds to the fifth view frustum 224 of the fifth eye capture camera 210, the gaze tracking component 214 may turn on 262 the fifth eye capture camera 210 and may invoke the fifth eye capture camera 210 to obtain eye region imagery of the second user 262 at or around the fourth time T4. Gaze tracking information may be generated for the second user 262 at the fourth time T4. One or more tasks may be performed on behalf of the first user 232 based upon gaze tracking information of the first user 232 at the fourth time T4 and/or one or more tasks may be performed on behalf of the second user 262 based upon gaze tracking information of the second user 262 at the fourth time T4.

FIG. 2F illustrates an example 270 of the gaze tracking component 214 selectively utilizing one or more eye capture cameras for gaze tracking of multiple users. In an example, the user tracking component 212 may obtain first user tracking data indicating that the first user 232 is within a fourth spatial location at a fifth time T5 and may obtain second user tracking data indicating that the second user 262 is within a fifth spatial location at the fifth time T5. Because the fourth spatial location and the fifth spatial location correspond to the fourth view frustum 222 of the fourth eye capture camera 208, the gaze tracking component 214 may turn on 278 the fourth eye capture camera 208 and may invoke the fourth eye capture camera 208 to obtain eye region imagery of the first user 232 at or around the fifth time T5 and eye region imagery of the second user 262 at or around the fifth time T5. The gaze tracking component may power down 272 the second eye capture camera 204, power down 274 the third eye capture camera 206, and power down 280 the fifth eye capture camera 210 based upon the second view frustum 218, the third view frustum 220, and the fifth view frustum 224 not corresponding to the fourth spatial location and/or the fifth spatial location. Gaze tracking information may be generated for the first user 232 at the fifth time T5 and for the second user 262 at the fifth time T5 based upon the eye region imagery of the first user 232 and the second user 262 captured by the fourth eye capture camera 208. One or more tasks may be performed on behalf of the first user 232 based upon the gaze tracking information of the first user 232 at the fifth time T5 and/or one or more tasks may be performed on behalf of the second user 262 based upon the gaze tracking information of the second user 262 at the fifth time T5.

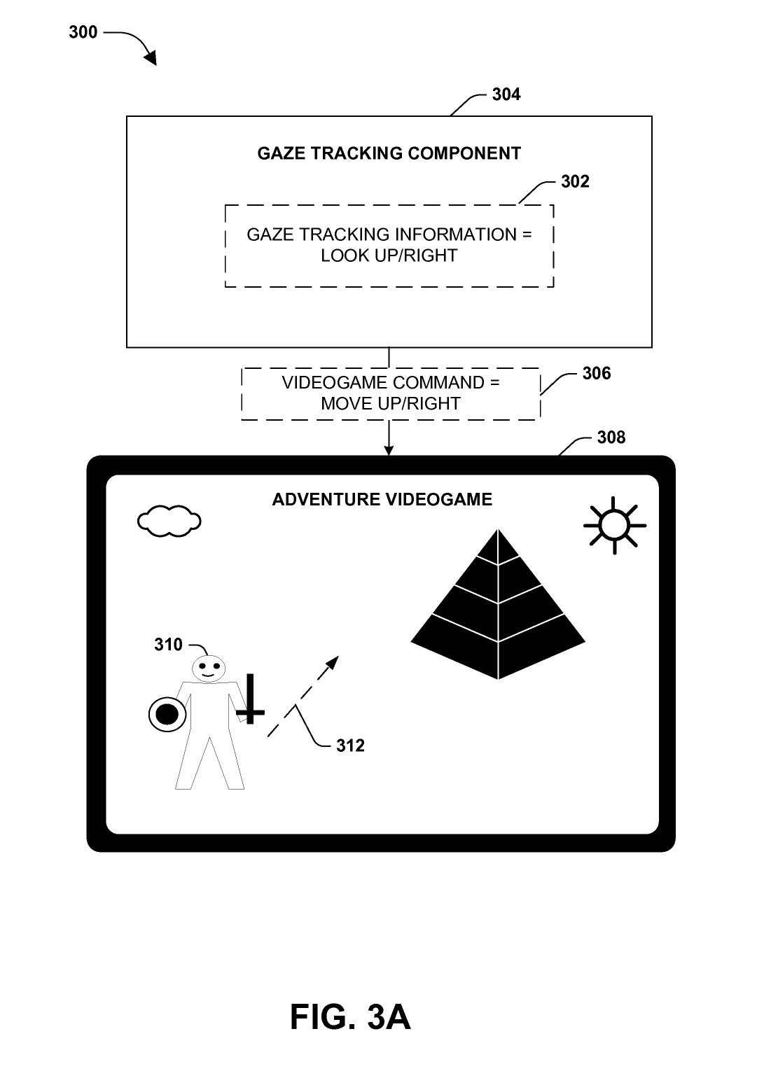

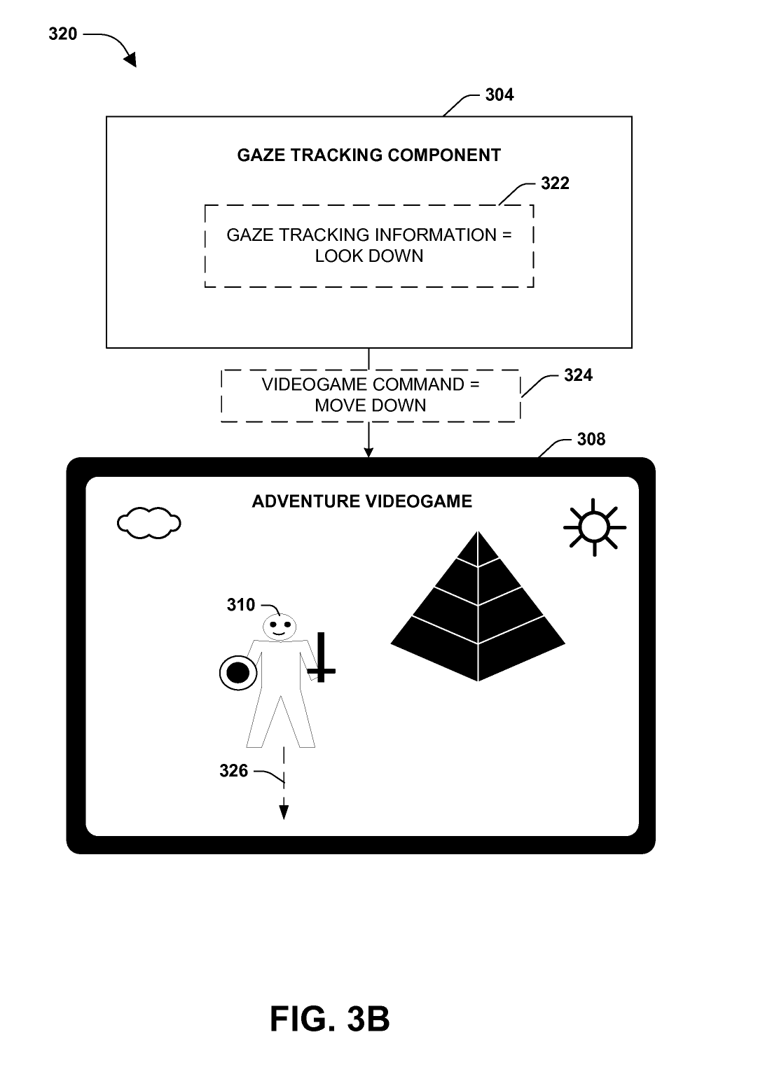

FIG. 3A illustrates an example 300 of performing a first task (e.g., a videogame command) based upon gaze tracking information 302 for a first user at a first time T1. A gaze tracking component 304 may generate the gaze tracking information 302 based upon eye region imagery of the first user obtained by one or more eye capture cameras. For example, the gaze tracking component 304 may invoke a first eye capture camera to obtain first eye region imagery of the first user at the first time T1 (e.g., the first user may look up and to the right) based upon a user tracking component indicating that a first spatial location of the first user at the first time T1 is within a first view frustum of the first eye capture camera. The gaze tracking component 304 may determine that a look up and right gaze input is mapped to a move avatar up and right videogame command 306 for an adventure videogame 308. Accordingly, an avatar 310 may be moved 312 up and to the right.

FIG. 3B illustrates an example 320 of performing a second task (e.g., a videogame command) based upon second gaze tracking information 322 for the first user at a second time T2. The gaze tracking component 304 may generate the second gaze tracking information 322 based upon second eye region imagery of the first user obtained by one or more eye capture cameras. For example, the gaze tracking component 304 may invoke a second eye capture camera to obtain second eye region imagery of the first user at the second time T2 (e.g., the first user may look down) based upon the user tracking component indicating that a second spatial location of the first user at the second time T2 is within a second view frustum of the second eye capture camera. The gaze tracking component 304 may determine that a look down gaze input is mapped to a move avatar down videogame command 324 for the adventure videogame 308. Accordingly, the avatar 310 may be moved 326 down.

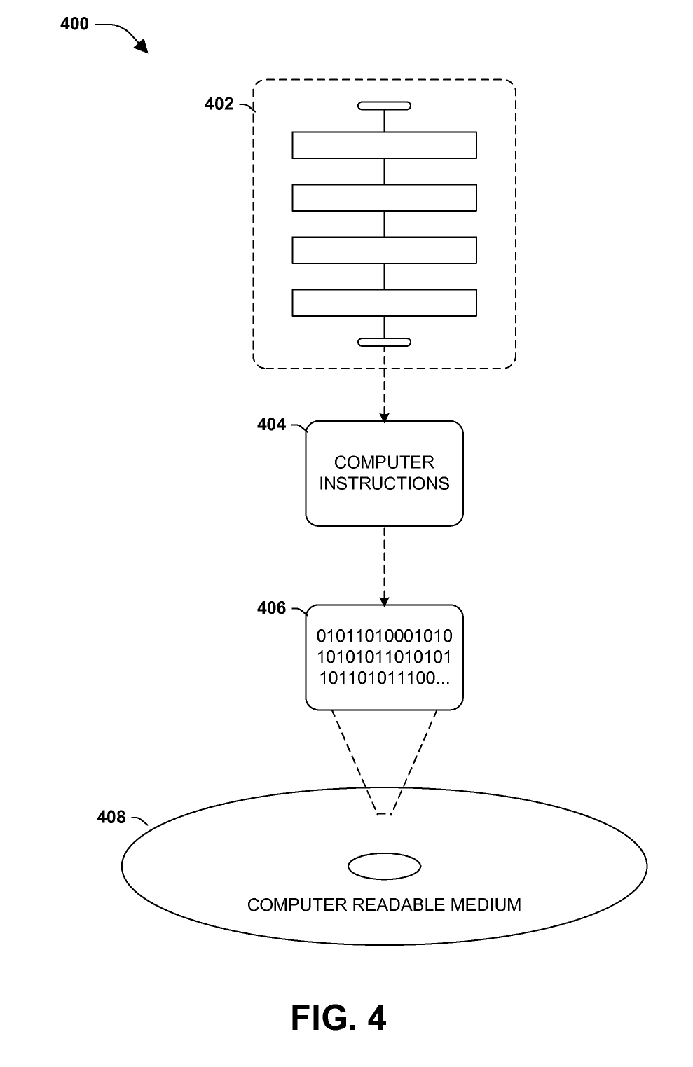

Still another embodiment involves a computer-readable medium comprising processor-executable instructions configured to implement one or more of the techniques presented herein. An example embodiment of a computer-readable medium or a computer-readable device is illustrated in FIG. 4, wherein the implementation 400 comprises a computer-readable medium 408, such as a CD-R, DVD-R, flash drive, a platter of a hard disk drive, etc., on which is encoded computer-readable data 406. This computer-readable data 406, such as binary data comprising at least one of a zero or a one, in turn comprises a set of computer instructions 404 configured to operate according to one or more of the principles set forth herein. In some embodiments, the processor-executable computer instructions 404 are configured to perform a method 402, such as at least some of the exemplary method 100 of FIG. 1, for example. In some embodiments, the processor-executable instructions 404 are configured to implement a system, such as at least some of the exemplary system 201 of FIGS. 2A-2F, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

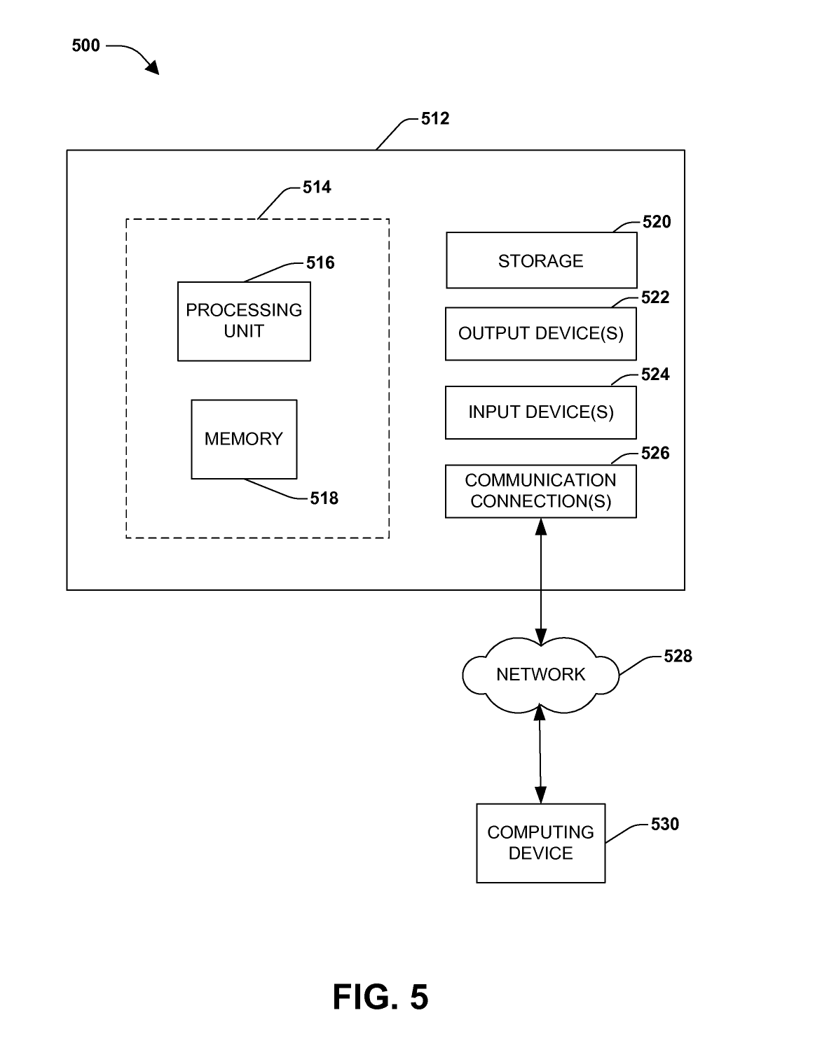

FIG. 5 and the following discussion provide a brief, general description of a suitable computing environment to implement embodiments of one or more of the provisions set forth herein. The operating environment of FIG. 5 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 5 illustrates an example of a system 500 comprising a computing device 512 configured to implement one or more embodiments provided herein. In one configuration, computing device 512 includes at least one processing unit 516 and memory 518. Depending on the exact configuration and type of computing device, memory 518 may be volatile (such as RAM, for example), non-volatile (such as ROM, flash memory, etc., for example) or some combination of the two. This configuration is illustrated in FIG. 5 by dashed line 514.

In other embodiments, device 512 may include additional features and/or functionality. For example, device 512 may also include additional storage (e.g., removable and/or non-removable) including, but not limited to, magnetic storage, optical storage, and the like. Such additional storage is illustrated in FIG. 5 by storage 520. In one embodiment, computer readable instructions to implement one or more embodiments provided herein may be in storage 520. Storage 520 may also store other computer readable instructions to implement an operating system, an application program, and the like. Computer readable instructions may be loaded in memory 518 for execution by processing unit 516, for example.

The term “computer readable media” as used herein includes computer storage media. Computer storage media includes volatile and nonvolatile, removable and non-removable media implemented in any method or technology for storage of information such as computer readable instructions or other data. Memory 518 and storage 520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 512. Computer storage media does not, however, include propagated signals. Rather, computer storage media excludes propagated signals. Any such computer storage media may be part of device 512.

Device 512 may also include communication connection(s) 526 that allows device 512 to communicate with other devices. Communication connection(s) 526 may include, but is not limited to, a modem, a Network Interface Card (NIC), an integrated network interface, a radio frequency transmitter/receiver, an infrared port, a USB connection, or other interfaces for connecting computing device 512 to other computing devices. Communication connection(s) 526 may include a wired connection or a wireless connection. Communication connection(s) 526 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 512 may include input device(s) 524 such as keyboard, mouse, pen, voice input device, touch input device, infrared cameras, video input devices, and/or any other input device. Output device(s) 522 such as one or more displays, speakers, printers, and/or any other output device may also be included in device 512. Input device(s) 524 and output device(s) 522 may be connected to device 512 via a wired connection, wireless connection, or any combination thereof. In one embodiment, an input device or an output device from another computing device may be used as input device(s) 524 or output device(s) 522 for computing device 512.

Components of computing device 512 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 512 may be interconnected by a network. For example, memory 518 may be comprised of multiple physical memory units located in different physical locations interconnected by a network.

Those skilled in the art will realize that storage devices utilized to store computer readable instructions may be distributed across a network. For example, a computing device 530 accessible via a network 528 may store computer readable instructions to implement one or more embodiments provided herein. Computing device 512 may access computing device 530 and download a part or all of the computer readable instructions for execution. Alternatively, computing device 512 may download pieces of the computer readable instructions, as needed, or some instructions may be executed at computing device 512 and some at computing device 530.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A system for gaze tracking, comprising:
a gaze tracking component configured to:
utilize a user tracking component to obtain first user tracking data for a first user at a first time T1;
evaluate the first user tracking data to identify a first spatial location of the first user at the first time T1;
select a first eye capture camera from an eye capture camera configuration based upon the first eye capture camera having a first view frustum corresponding to the first spatial location, the eye capture camera configuration comprising a plurality of eye capture cameras having a fixed view frustum configuration;
invoke the first eye capture camera to obtain first eye region imagery of the first user at the first time T1; and
generate first gaze tracking information for the first user at the first time T1 based upon the first eye region imagery.

2. The system of claim 1, the gaze tracking component configured to:
perform a task based upon the first gaze tracking information.

3. The system of claim 1, the gaze tracking component configured to:
predict a potential new spatial location of the first user; and
responsive to the potential new spatial location corresponding to a second view frustum for eye capture camera, awaken the second eye capture camera into a capture ready state for obtaining eye region imagery.

4. The system of claim 1, the gaze tracking component configured to:
maintain one or more eye capture cameras of the eye capture camera configuration in a powered down state at the first time T1 based upon the one or more eye capture cameras having view frustums not corresponding to the first spatial location.

5. The system of claim 1, the gaze tracking component configured to:
responsive to the first user tracking data indicating that the first user is, at a second time T2, within a second spatial location to which the first view frustum does not correspond, transition the first eye capture camera into a powered down state at the second time T2.

6. The system of claim 1, the gaze tracking component configured to:
select a second eye capture camera from the eye capture camera configuration based upon the second eye capture camera having a second view frustum corresponding to the first spatial location;
invoke the second eye capture camera to obtain second eye region imagery of the first user at the first time T1; and
combine the first eye region imagery and the second eye region imagery to generate the first gaze tracking information.

7. The system of claim 1, the gaze tracking component configured to:
responsive to the first user tracking data indicating that the first user is, at a second time T2, within a second spatial location:
select a second eye capture camera from the eye capture camera configuration based upon the second eye capture camera having a second view frustum corresponding to the second spatial location;
transition, at the second time T2, the first eye capture camera into a powered down state based upon the first view frustum not corresponding to the second spatial location;
invoke the second eye capture camera to obtain second eye region imagery of the first user at the second time T2; and
generate second gaze tracking information for the first user at the second time T2 based upon the second eye region imagery.

8. The system of claim 1, the gaze tracking component configured to:
utilize the user tracking component to obtain second user tracking data for a second user at the first time T1;
evaluate the second user tracking data to identify a second spatial location of the second user at the first time T1;
select a second eye capture camera from the eye capture camera configuration based upon the second eye capture camera having a second view frustum corresponding to the second spatial location;
invoke the second eye capture camera to obtain second eye region imagery of the second user at the first time T1; and
generate second gaze tracking information for the second user at the first time T1 based upon the second eye region imagery.

9. The system of claim 8, the gaze tracking component configured to:
concurrently track the first gaze tracking information for the first user and the second gaze tracking information for the second user.

10. The system of claim 1, first eye capture camera having a first resolution that is greater than a second resolution of the user tracking component.

11. The system of claim 1, the gaze tracking component configured to:
selectively utilize eye capture cameras of the eye capture camera configuration to concurrently track gaze tracking information of one or more users.

12. The system of claim 1, the gaze tracking component configured to:
turn on a pupil illumination structure of the first eye capture camera to invoke the first eye capture camera to obtain the first eye region imagery.

13. The system of claim 1, the gaze tracking component configured to:
turn on an LED dark pupil structure; and
invoke the first eye capture camera to capture glint corneal reflection data resulting from the LED dark pupil structure to obtain the first eye region imagery.

14. The system of claim 1, the user tracking component comprising at least one of a depth camera, a passive sensor, an active sensor, an infrared device, a time of flight device, or a camera.

15. The system of claim 1, at least one of the eye capture cameras of the eye capture camera configuration having a horizontal view of about 20 degrees to about 40 degrees and a vertical view of about 10 degrees to about 30 degrees frustum.

16. A method for gaze tracking, comprising:
utilizing a user tracking component to obtain first user tracking data for a first user at a first time T1;
evaluating the first user tracking data to identify a first spatial location of the first user at the first time T1;
selecting a first eye capture camera from an eye capture camera configuration based upon the first eye capture camera having a first view frustum corresponding to the first spatial location, the eye capture camera configuration comprising a plurality of eye capture cameras having a fixed view frustum configuration;
invoking the first eye capture camera to obtain first eye region imagery of the first user at the first time T1; and
generating first gaze tracking information for the first user at the first time T1 based upon the first eye region imagery.

17. The method of claim 16, comprising:
maintaining one or more eye capture cameras of the eye capture camera configuration in a powered down state at the first time T1 based upon the one or more eye capture cameras having view frustums not corresponding to the first spatial location.

18. The method of claim 16, comprising:
responsive to the first user tracking data indicating that the first user is, at a second time T2, within a second spatial location:
selecting a second eye capture camera from the eye capture camera configuration based upon the second eye capture camera having a second view frustum corresponding to the second spatial location;
transitioning, at the second time T2, the first eye capture camera into a powered down state based upon the first view frustum not corresponding to the second spatial location;
invoking the second eye capture camera to obtain second eye region imagery of the first user at the second time T2; and
generating second gaze tracking information for the first user at the second time T2 based upon the second eye region imagery.

19. The method of claim 16, comprising:
utilizing the user tracking component to obtain second user tracking data for a second user at the first time T1;
evaluating the second user tracking data to identify a second spatial location of the second user at the first time T1;
selecting a second eye capture camera from the eye capture camera configuration based upon the second eye capture camera having a second view frustum corresponding to the second spatial location;
invoking the second eye capture camera to obtain second eye region imagery of the second user at the first time T1; and
generating second gaze tracking information for the second user at the first time T1 based upon the second eye region imagery.

20. A computer readable medium comprising instructions which when executed perform a method for concurrently tracking gaze tracking information for multiple users, comprising:
tracking a first user, comprising:
utilizing a user tracking component to obtain first user tracking data for the first user at a first time T1;
evaluating the first user tracking data to identify a first spatial location of the first user at the first time T1;
selecting a first eye capture camera from an eye capture camera configuration based upon the first eye capture camera having a first view frustum corresponding to the first spatial location, the eye capture camera configuration comprising a plurality of eye capture cameras;
invoking the first eye capture camera to obtain first eye region imagery of the first user at the first time T1; and
generating first gaze tracking information for the first user at the first time T1 based upon the first eye region imagery; and
concurrently tracking a second user while tracking the first user, comprising:
utilizing the user tracking component to obtain second user tracking data for the second user at the first time T1;
evaluating the second user tracking data to identify a second spatial location of the second user at the first time T1;
selecting a second eye capture camera from the eye capture camera configuration based upon the second eye capture camera having a second view frustum corresponding to the second spatial location;
invoking the second eye capture camera to obtain second eye region imagery of the second user at the first time T1; and
generating second gaze tracking information for the second user at the first time T1 based upon the second eye region imagery.
